(19) United States
(12) Patent Application Publication
(10) Pub. No.: US 2024/0241556 A1
(43) Pub. Date: Jul. 18, 2024

(54) DEVICE POWER MANAGEMENT UNIT AND METHODS OF PERFORMING THE SAME

(71) Applicant: Felipe Manuel Lopez, Hoffman Estates, IL (US)

(72) Inventor: Felipe Manuel Lopez, Hoffman Estates, IL (US)

(21) Appl. No.: 18/407,588

(22) Filed: Jan. 9, 2024

Related U.S. Application Data
(60) Provisional application No. 63/480,131, filed on Jan. 17, 2023.

(51) Int. Cl. G06F 1/26; G06F 1/24

(52) U.S. Cl. CPC G06F 1/266; G06F 1/24

(57) ABSTRACT

A device control unit including a central processing unit communicatively coupled to a plurality of ports, a plurality of device connection cables each connected to a respective port on one end and to a port on each controlled device, a power switching cable connected to the port on the controlled device on one end and to a power switch in the controlled device on the second end, wherein the central processing unit sends commands to the power switch in the controlled device to change the powered state of the controlled device.

### Cross Reference to Related Applications

This application claims the benefit of and the priority from U.S. Provisional Patent Application No. 63/480,131 filed Jan. 17, 2023, titled “ATX POWER SWITCH WHICH ALLOWS POWERING COMPUTERS ON AND OFF FROM ANOTHER COMPUTER,” which is incorporated herein by reference.

### BACKGROUND OF THE INVENTION

Computers require rebooting from time to time to restore normal operation. The computer cannot reset itself whenever the operating system becomes unresponsive, and a hard reset is required instead. The hard reset requires pressing the power button on the computer for a few seconds to power off the computer and pressing it again to power it back on. The power button requires physical computer access, which is a problem for computers in remote locations, including data centers, employees working from home, or when access to the computer is inconvenient. The issue is compounded when the remote location houses multiple computers.

The industry has existing devices and technologies that, in combination, might accomplish the same task. For example, smart power strips can cut off power to an appliance, including computers, to shut them off. Wake on LAN and Wake on Power technologies can be used to start a computer that is turned off when an external event occurs. Some devices can power on and off a single computer, including several KVM-based technologies. These existing technologies cannot independently accomplish a complete power cycle, require more configuration and understanding of each system, or cannot control multiple computers.

The operating system cannot power the computer off and on when it becomes unresponsive. The operating system cannot start a computer when the computer is turned off. KVM-based solutions only work well to hard reset a single computer because they are designed to work with one computer. Smart Power Strips do not work well because they can only power off devices but cannot signal devices to power back on. Wake on LAN and Wake on Power do not work well because they can only be used if the computer supports it and can only power computers on but cannot power them off.

In short, to complete a hard reset when the operating system becomes unresponsive, existing technologies require configuring one device per computer, can only power off the computer like smart power strips, or can only start the computer like Wake on LAN or Wake on Power but only if the BIOS or operating system support it.

### SUMMARY OF THE INVENTION

Systems, methods, features, and advantages of the present invention will be or will become apparent to one with skill in the art upon examination of the following figures and detailed description. It is intended that all such additional systems, methods, features, and advantages be included within this description, be within the scope of the invention, and be protected by the accompanying claims.

One embodiment of the present disclosure includes a device control unit having a central processing unit communicatively coupled to a plurality of ports, a plurality of device connection cables each connected to a respective port on one end and to a port on each controlled device, a power switching cable connected to the port on the controlled device on one end and to a power switch in the controlled device on the second end where the central processing unit sends commands to the power switch in the controlled device to change the powered state of the controlled device.

In another embodiment, an activity indicator unit indicates an activity on an associated one of the plurality of ports.

In another embodiment, an optical isolated circuit is between each port and the central processing unit.

In another embodiment, the activity indicator unit is a light.

In another embodiment, the command is to mimic the pressing of a power button on and off on the controlled device.

In another embodiment, each command is sent to the device control unit via an external device.

In another embodiment, the command is to power the device off for a period of time and then to power the device on.

In another embodiment, the command is to perform a hard reset of the device.

In another embodiment, the external device is connected to the device control unit via a communication cable.

In another embodiment, the external device communicates with the device control unit wirelessly.

Another embodiment includes a method of controlling an external device via a device control unit having software in memory that performs the steps of receiving a command from an external device, determining the type of command to execute, retrieving a control sequence based on the received and determined command, and transmitting the control sequence via a first port on the device control unit to a second port on the external device and a cable connected between the second port and a power switch on the external device.

Another embodiment includes the step of changing an activity indicator unit associated with at least one port when the respective port transmits a control sequence.

In another embodiment, each port includes an optically isolated circuit.

In another embodiment, the activity indicator unit is a light.

In another embodiment, the control sequence mimics the pressing of a power button on and off on the controlled device.

In another embodiment, the first port is a mono jack port.

In another embodiment, the control sequence powers the controlled device off for a period of time and then powers the controlled device on.

In another embodiment, the control sequence performs a hard reset of the device.

In another embodiment, the external device is connected to the device control unit via a communication cable.

In another embodiment, the external device communicates with the device control unit wirelessly.

### BRIEF DESCRIPTION OF THE DRAWINGS

The accompanying drawings, which are incorporated in and constitute a part of this specification, illustrate an implementation of the present invention and, together with the description, serve to explain the advantages and principles of the invention. In the drawings:

FIG. 1 depicts one embodiment of remote device control system consistent with the present invention;

FIG. 2 depicts one embodiment of a device control unit;

FIG. 3 depicts one embodiment of a communication device consistent with the present invention;

FIG. 4 depicts a front view of a device control unit;

FIG. 5 depicts a side view of a device connection cable;

FIG. 6 depicts a top view of a cable used to interface with a device controlled by the device control unit;

FIG. 7 depicts the cable interfacing with a computer motherboard;

FIG. 8 depicts a photo isolation circuit used in each output port; and

FIG. 9 depicts a schematic representation of the operation of the device control unit.

### DETAILED DESCRIPTION OF THE INVENTION

Referring now to the drawings which depict different embodiments consistent with the present invention, wherever possible, the same reference numbers will be used throughout the drawings and the following description to refer to the same or like parts.

The device control system allows for the cycling of power to remote devices without requiring in person physical interaction with the devices. The device includes a series of ports that are each connected to a device, such as a computer. Each controlled device includes a port and cables that are connected to power switches inside the controlled device. An external computer sends commands to the controlled devices via the device control unit. The external computers send commands to the device control unit, which causes the device control unit to send electrical signals to the power switches in the controlled device.

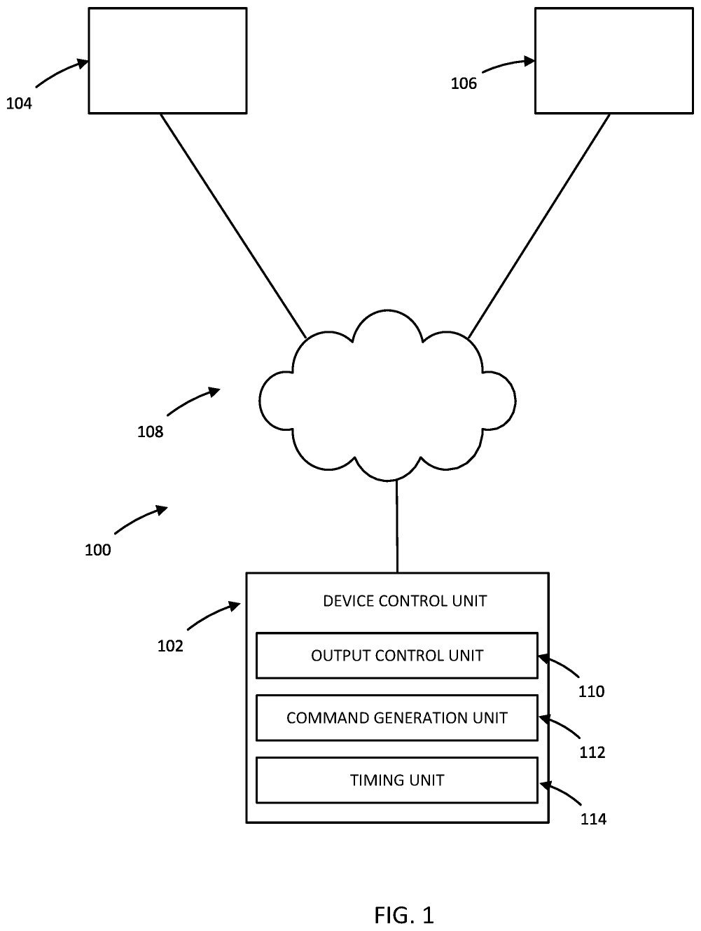

FIG. 1 depicts one embodiment of remote device control system 100 consistent with the present invention. The remote device control system 100 includes a device control unit 102, a communication device 1 104, a communication device 2 106 each communicatively connected via a network 108. The device control unit 102 further includes an output control unit 110, a command generation unit 112, and a timing unit 114.

The output control unit 110 and command generation unit 112 may be embodied by one or more servers. Alternatively, timing unit 114 may be implemented using any combination of hardware and software, whether as incorporated in a single device or as a functionally distributed across multiple platforms and devices.

In one embodiment, the network 108 is a cellular network, a TCP/IP network, or any other suitable network topology. In another embodiment, the device control system 100 may be servers, workstations, network appliances or any other suitable data storage devices. In another embodiment, the communication devices 104 and 106 may be any combination of cellular phones, telephones, personal data assistants, or any other suitable communication devices. In one embodiment, the network 108 may be any private or public communication network known to one skilled in the art such as a local area network (“LAN”), wide area network (“WAN”), peer-to-peer network, cellular network or any suitable network, using standard communication protocols. The network 108 may include hardwired as well as wireless branches.

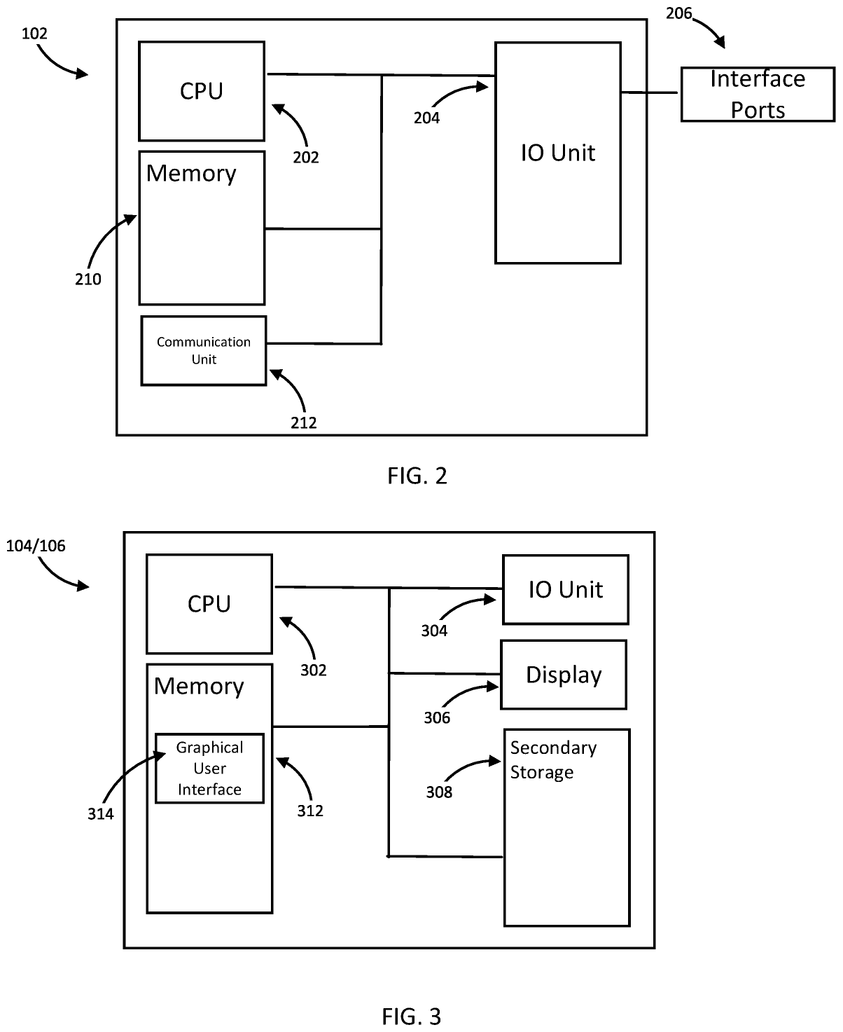

FIG. 2 depicts one embodiment of a device control unit 102. The device control unit 102 includes an I/O device 204 connected to at least interface port 206, a processor 202, and a memory 210 In one embodiment, the processor 202 may be a central processing unit (“CPU”), an application specific integrated circuit (“ASIC”), a microprocessor or any other suitable processing device. The memory 210 may include a hard disk, random access memory, cache, removable media drive, mass storage or configuration suitable as storage for data, instructions, and information. In one embodiment, the memory 210 and processor 202 may be integrated. The memory may use any type of volatile or non-volatile storage techniques and mediums. A communication unit 212 allows for communication with external devices via wireless protocols including near field communication, Bluetooth communication or any other wireless communication.

FIG. 3 depicts one embodiment of a communication device 104/106 consistent with the present invention. The communication device 104/106 includes a processor 302, a network I/O Unit 304, an image display unit 306, a secondary storage unit 308 and memory 312 running a graphical user interface 314. In one embodiment, the processor 302 may be a central processing unit (“CPU”), an application specific integrated circuit (“ASIC”), a microprocessor or any other suitable processing device. The memory 312 may include a hard disk, random access memory, cache, removable media drive, mass storage or configuration suitable as storage for data, instructions, and information. In one embodiment, the memory 312 and processor 302 may be integrated. The memory may use any type of volatile or non-volatile storage techniques and mediums. The network I/O device 304 may be a network interface card, a plain old telephone service (“POTS”) interface card, an ASCII interface card, or any other suitable network interface device.

In one embodiment, the network 108 may be any private or public communication network known to one skilled in the art such as a Local Area Network (“LAN”), Wide Area Network (“WAN”), Peer-to-Peer Network, Cellular network or any suitable network, using standard communication protocols. The network 108 may include hardwired as well as wireless branches.

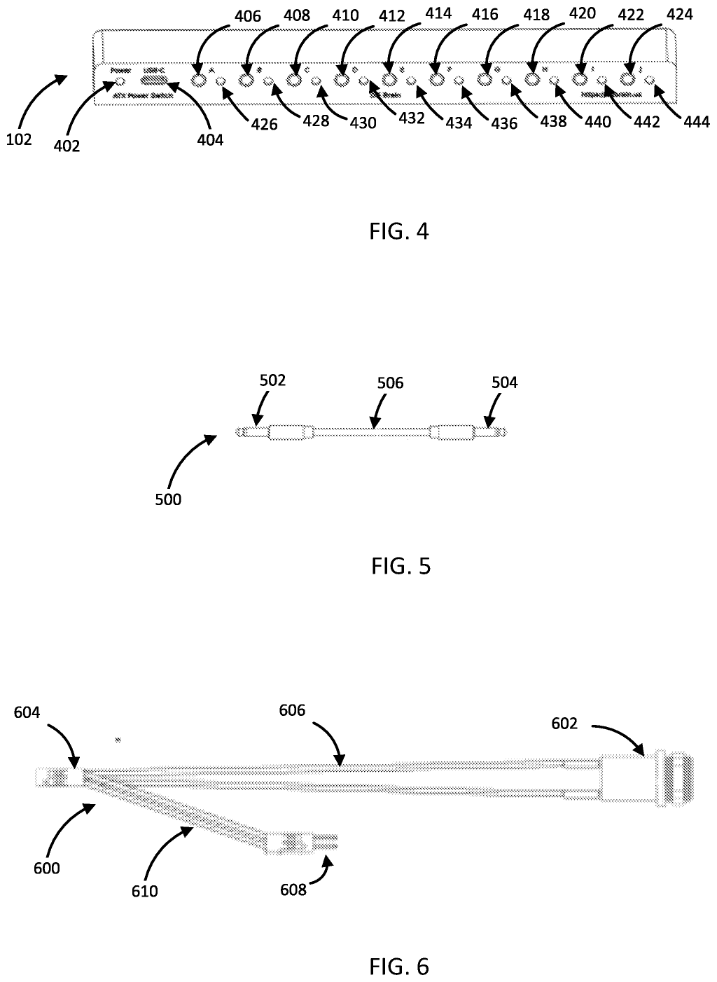

FIG. 4 depicts a front view of a device control unit 102. The device control unit 102 includes a power switch 402 that posers the device control unit 102 on and off, a communications port 404 that communicatively couples the device control unit 102 to an external computer 104/106. In one embodiment, the computer 104/106 is connected to the device control unit 102 via a universal serial bus cable. In another embodiment, the computer 104/106 is connected to the device control unit 104/106 via a wireless communication device such as a Bluetooth or Wi-Fi connection. The device control unit 102 includes a plurality of control output ports 406-424. The device output ports 406-424 are each configured to receive a male connector for communication with an external device. In one embodiment, each device output port 406-424 is configured to receive a mono plug. An activity indicator unit 426-444 is positioned adjacent to each device output port 406-424. Each activity indicator unit 426-44 provides a visual indicator of the current operation of the device output port 406-424.

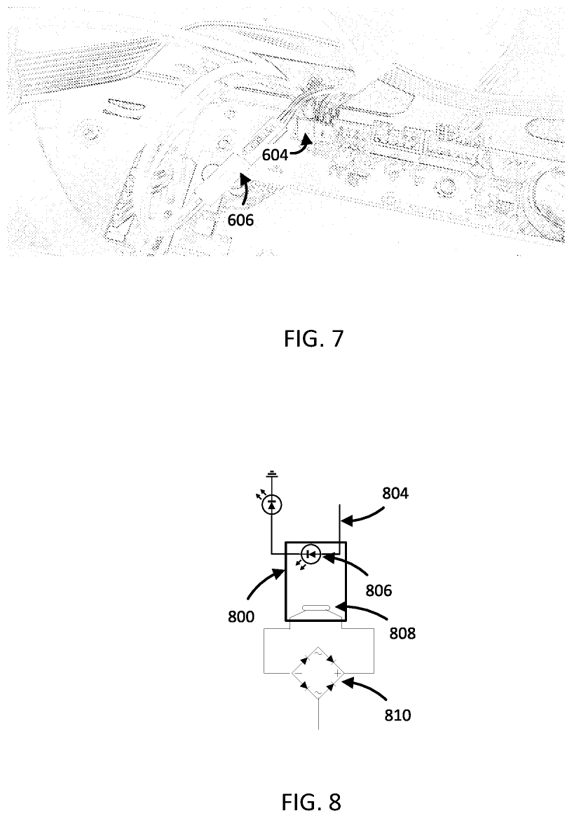

FIG. 5 depicts a side view of a device connection cable 500. The device connection cable 500 includes a first connector 502 connected to a second connector 504 by a cable 506. The device connection cable 500 connects the first connector to a device output port 406-424 on the device control unit 402 and the second connector 404 to a port on a device controlled by the device control unit 102. FIG. 6 depicts a top view of a cable 600 used to interface with a device controlled by the device control unit 102. The cable 600 includes a female mono jack 602 that is configured to receive a male mono plug. The female mono jack 602 is connected to a second two prong female connector 604 by wires 606. A third two pin male connector 608 is connected to the two prong female connector 604 by wires 610. FIG. 7 depicts the cable 600 interfacing with a controlled computer motherboard. The second female prong connector 604 connects to a power port on the motherboard and the third two pin connector 608 connects with the computer power switch. In operation, when a signal is sent form the digital control unit to the power port and power switch, the computer will power down and restart.

FIG. 8 depicts a photo isolation circuit used in each output port 406-424. The photo isolation circuit 800 receives a control signal from the CPU 202 into the input 804. The signal illuminates a first LED 806 inside the photo isolation circuit 800 and also illuminates the activity indicator unit 426-444 associated with the output port 406-424. Light from the first LED 806 is detected by a photo cell 808, which passes the signal through a rectifier 810 and out to the output port. By using the LED/Photodetector isolation circuit, the device control unit 102 and devices connected to each output pots 406-424 are protected from outside electrical spikes and transients.

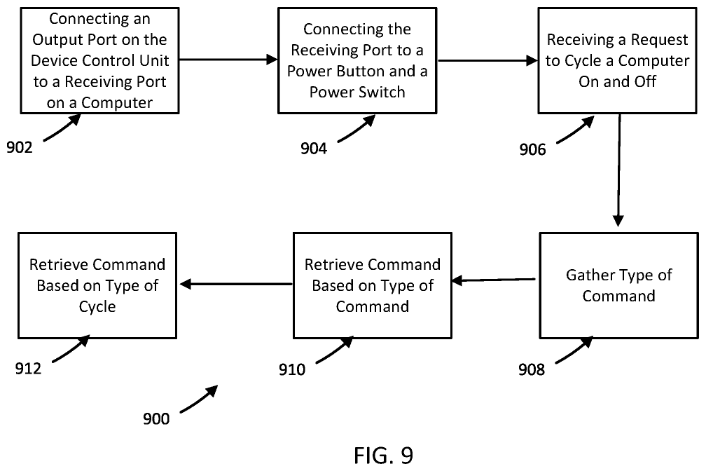

FIG. 9 depicts a schematic representation 900 of the operation of the device control unit 102. In step 902, an output port 406-424 is connected to a computer via a device connection cable 500. One end of the device connection cable 500 is inserted into the device control unit 102 output port 406-424 and the opposing end is plugged into the female mono jack 602 on the cable 600. In one embodiment, the female mono jack 602 is engage in an opening in a peripheral component interface cover. In step 904, the female prong connector 604 engages a power switch on the mother board of the device to be controlled. In step 906, a command to reset a device connected to the device control unit 102 is received. In one embodiment, the command includes the port number on the device control unit 102 along with a description of the command and the command starting that will be processed by the CPU 202. In step 908, the CPU 202 determines the type of command to execute. In one embodiment, the command is to turn the connected device off. In another embodiment, the command is to mimic the pressing and release of a power switch. In another embodiment, the command is to perform a hard reset of a device.

In step 910, the specific command to execute is retrieved based on the type of command determined by the CPU 202. In one embodiment, the command is to close the circuit to the controlled device for 0.5 seconds. In another embodiment, the command is to close the contact to the controlled device for five seconds. In another embodiment, the command is to send a five second signal followed by a second signal sent a predetermined time after the first signal.

While various embodiments of the present invention have been described, it will be apparent to those of skill in the art that many more embodiments and implementations are possible that are within the scope of this invention. Accordingly, the present invention is not to be restricted except in light of the attached claims and their equivalents.

What is claimed:

1. A device control unit including:
a central processing unit communicatively coupled to a plurality of ports;
a plurality of device connection cables each connected to a respective port on one end and to a port on each controlled device;
a power switching cable connected to the port on the controlled device on one end and to a power switch in the controlled device on the second end;
wherein,
the central processing unit sends commands to the power switch in the controlled device to change the powered state of the controlled device.

2. The device control unit of claim 1, including an activity indicator unit that indicates an activity on an associated one of the plurality of ports.

3. The device control unit of claim 1, including an optical isolated circuit between each port and the central processing unit.

4. The device control unit of claim 2, wherein the activity indicator unit is a light.

5. The device control unit of claim 1, wherein the command is to mimic the pressing of a power button on and off on the controlled device.

6. The device control unit of claim 1, wherein each command is sent to the device control unit via an external device.

7. The device control unit of claim 1, wherein the command is to power the device off for a period of time and then to power the device on.

8. The device of claim 1, wherein the command is to perform a hard reset of the device.

9. The device of claim 6, wherein the external device is connected to the device control unit via a communication cable.

10. The device of claim 9, wherein the external device communicates with the device control unit wirelessly.

11. A method of controlling an external device via a device control unit having software in memory that performs the steps of:
receiving a command from an external device;
determining the type of command to execute;
retrieving a control sequence based on the received and determined command;
transmitting the control sequence via a first port on the device control unit to a second port on the external device and a cable connected between the second port and a power switch on the external device.

12. The method of claim 11, including the step of changing an activity indicator unit associated with at least one port when the respective port transmits a control sequence.

13. The method of claim 11, wherein each port includes an optically isolated circuit.

14. The method of claim 13, wherein the activity indicator unit is a light.

15. The method of claim 11, wherein the control sequence mimics the pressing of a power button on and off on the controlled device.

16. The method of claim 11, wherein the first port is a mono jack port.

17. The method of claim 11, wherein the control sequence powers the controlled device off for a period of time and then powers the controlled device on.

18. The device of claim 1, wherein the control sequence performs a hard reset of the device.

19. The method of claim 11, wherein the external device is connected to the device control unit via a communication cable.

20. The method of claim 19, wherein the external device communicates with the device control unit wirelessly.
